(19) United States
(12) Patent Application Publication
(10) Pub. No.: US 2005/0246766 A1
(43) Pub. Date: Nov. 3, 2005

(54) System and method for handling certificate revocation lists

(76) Inventors: Michael G. Kirkup, Waterloo (CA); Herbert A. Little, Waterloo (CA); Michael K. Brown, Peterborough (CA)

Correspondence Address: John V. Biernacki, Esq.;JONES DAY, North Point, 901 Lakeside Avenue, Cleveland, OH, 44114, US

(21) Appl. No.: 10/998,209

(22) Filed: Nov. 26, 2004

Related U.S. Application Data
(60) Provisional application No. 60/567,159, filed on Apr. 30, 2004.

(51) Int. Cl. H04L 9/00

(52) U.S. Cl. 726/6

(57) ABSTRACT

Systems and methods for verifying status of digital certificates received by mobile devices. A message server forwards messages sent to a mobile device. The messages may be encrypted with a digital certificate. A mobile device sends a request to the message server. The message server verifies the status of the certificate by comparing it with a previously downloaded CRL and sends a response with this information back to the mobile device.

### CROSS-REFERENCE TO RELATED APPLICATION

This application claims priority to and the benefit of U.S. Provisional Application Ser. No. 60/567,159, filed on Apr. 30, 2004, of which the entire disclosure (including any and all figures) of the application is incorporated herein by reference.

### TECHNICAL FIELD

This document relates generally to the field of communications, and in particular to handling certificate revocation lists on mobile wireless communications devices.

### BACKGROUND

One of the ways to provide security to communications is to encrypt information. Many cryptographic methods rely on “keys” and digital certificates assigned by Certificate Authorities. Keys are used to encrypt and decrypt a message. Digital certificates are used to verify that a message came from an authentic source. A digital certificate assigned to an entity can expire after some time, at which point it will become unusable. The expiration time of the certificate may be embedded in the digital certificate itself. There are instances however, when a digital certificate becomes unusable before its expiration time. In such instances the certificate is declared “revoked” by the Certificate Authority which has issued it. Whether the certificate authority has revoked the certificate is not apparent from examining the certificate itself. Some Public Key Infrastructure (PKI) systems include an Online Certificate Status Protocol (OCSP) RFC 2560 provider, which is a dedicated server used to provide access to the most up to date digital certificate status.

Other PKI systems do not use OCSP provider. Such systems rely on the use of Certificate Revocation Lists (CRLs) which contain a listing of all revoked certificates in the system. A way of using a CRL is for a system to download it, and when it is desired to verify the status of a certain certificate to check whether it appears in the CRL. These lists can become quite large over time and as such it becomes unwieldy to ask a user to download these lists to a resource constrained communication device.

### SUMMARY

In accordance with the teachings provided herein, systems and methods for operation upon data processing devices are provided in order to overcome one or more of the aforementioned disadvantages or other disadvantages concerning digital certificate processing. For example, a system and method can be configured to provide additional functionality to a server that forwards messages to mobile devices which will maintain a CRL. Resource constrained mobile devices request information about a digital certificate, and the server with the additional functionality responds with the status of that digital certificate.

As another example, a system and method can be configured to facilitate the ability of a resource constrained mobile wireless device to receive updated information about a certain digital certificate without having to download a CRL in PKI systems which do not maintain an OCSP provider. Still further, the disclosed systems and methods can be implemented on computer-readable media as well as through data signals which convey information from and/or to the systems.

### BRIEF DESCRIPTION OF THE DRAWINGS

FIG. 1 is a block diagram illustrating an exemplary communication network in which a mobile wireless device may be used;

FIG. 2 is a block diagram illustrating alternative paths of providing information to a mobile wireless device;

FIG. 3 is a block diagram illustrating components of a data service maintaining CRLs;

FIGS. 4 and 5 are flowcharts illustrating an operational scenario related to verifying a digital certificate status; and

FIG. 6 is a block diagram illustrating an exemplary implementation of a mobile wireless device.

### DETAILED DESCRIPTION

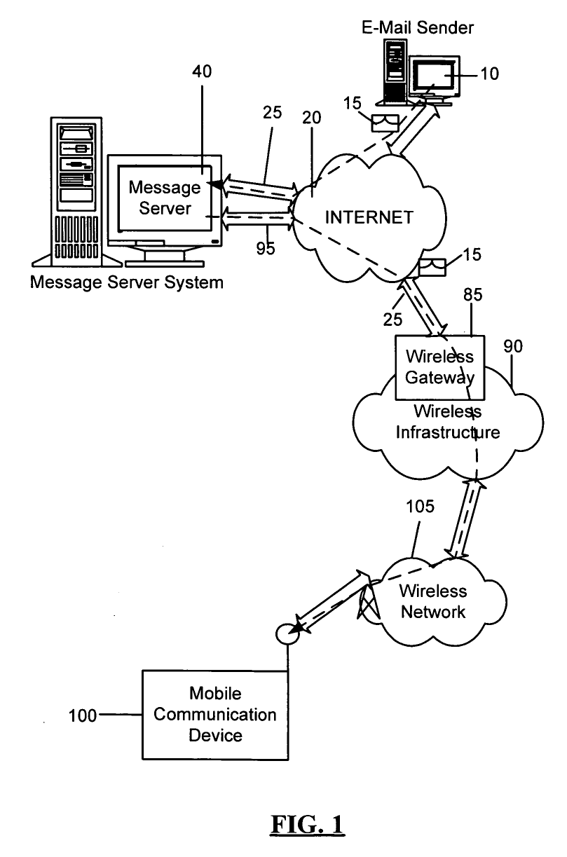

FIG. 1 is an overview of an example communication system in which a wireless communication device may be used. One skilled in the art will appreciate that there may be many different topologies, but the system shown in FIG. 1 helps demonstrate the operation of the encoded message processing systems and methods described in the present application. There may also be many message senders and recipients. The simple system shown in FIG. 1 is for illustrative purposes only, and shows perhaps the most prevalent Internet e-mail environment where security is not generally used.

FIG. 1 shows an e-mail sender 10, the Internet 20, a message server system 40, a wireless gateway 85, wireless infrastructure 90, a wireless network 105 and a mobile communication device 100.

An e-mail sender system 10 may, for example, be connected to an ISP (Internet Service Provider) on which a user of the system 10 has an account, located within a company, possibly connected to a local area network (LAN), and connected to the Internet 20, or connected to the Internet 20 through a large ASP (application service provider) such as America Online (AOL). Those skilled in the art will appreciate that the systems shown in FIG. 1 may instead be connected to a wide area network (WAN) other than the Internet, although e-mail transfers are commonly accomplished through Internet-connected arrangements as shown in FIG. 1.

The message server 40 may be implemented, for example, on a network computer within the firewall of a corporation, a computer within an ISP or ASP system or the like, and acts as the main interface for e-mail exchange over the Internet 20. Although other messaging systems might not require a message server system 40, a mobile device 100 configured for receiving and possibly sending e-mail will normally be associated with an account on a message server. Perhaps the two most common message servers are Microsoft Exchange™ and Lotus Domino™. These products are often used in conjunction with Internet mail routers that route and deliver mail. These intermediate components are not shown in FIG. 1, as they do not directly play a role in the secure message processing described below. Message servers such as server 40 typically extend beyond just e-mail sending and receiving; they also include dynamic database storage engines that have predefined database formats for data like calendars, to-do lists, task lists, e-mail and documentation.

The wireless gateway 85 and infrastructure 90 provide a link between the Internet 20 and wireless network 105. The wireless infrastructure 90 determines the most likely network for locating a given user and tracks the user as they roam between countries or networks. A message is then delivered to the mobile device 100 via wireless transmission, typically at a radio frequency (RF), from a base station in the wireless network 105 to the mobile device 100. The particular network 105 may be virtually any wireless network over which messages may be exchanged with a mobile communication device.

As shown in FIG. 1, a composed e-mail message 15 is sent by the e-mail sender 10, located somewhere on the Internet 20. This message 15 is normally fully in the clear and uses traditional Simple Mail Transfer Protocol (SMTP), RFC 822 headers and Multipurpose Internet Mail Extension (MIME) body parts to define the format of the mail message. These techniques are all well known to those skilled in the art. The message 15 arrives at the message server 40 and is normally stored in a message store. Most known messaging systems support a so-called “pull” message access scheme, wherein the mobile device 100 must request that stored messages be forwarded by the message server to the mobile device 100. Some systems provide for automatic routing of such messages which are addressed using a specific e-mail address associated with the mobile device 100. In a preferred embodiment described in further detail below, messages addressed to a message server account associated with a host system such as a home computer or office computer which belongs to the user of a mobile device 100 are redirected from the message server 40 to the mobile device 100 as they are received.

Regardless of the specific mechanism controlling the forwarding of messages to the mobile device 100, the message 15, or possibly a translated or reformatted version thereof, is sent to the wireless gateway 85. The wireless infrastructure 90 includes a series of connections to wireless network 105. These connections could be Integrated Services Digital Network (ISDN), Frame Relay or T1 connections using the TCP/IP protocol used throughout the Internet. As used herein, the term “wireless network” is intended to include three different types of networks, those being (1) data-centric wireless networks, (2) voice-centric wireless networks and (3) dual-mode networks that can support both voice and data communications over the same physical base stations. Combined dual-mode networks include, but are not limited to, (1) Code Division Multiple Access (CDMA) networks, (2) the Group Special Mobile or the Global System for Mobile Communications (GSM) and the General Packet Radio Service (GPRS) networks, and (3) future third-generation (3G) networks like Enhanced Data-rates for Global Evolution (EDGE) and Universal Mobile Telecommunications Systems (UMTS). Some older examples of data-centric network include the Mobitex™ Radio Network and the DataTAC™ Radio Network. Examples of older voice-centric data networks include Personal Communication Systems (PCS) networks like GSM, and TDMA systems.

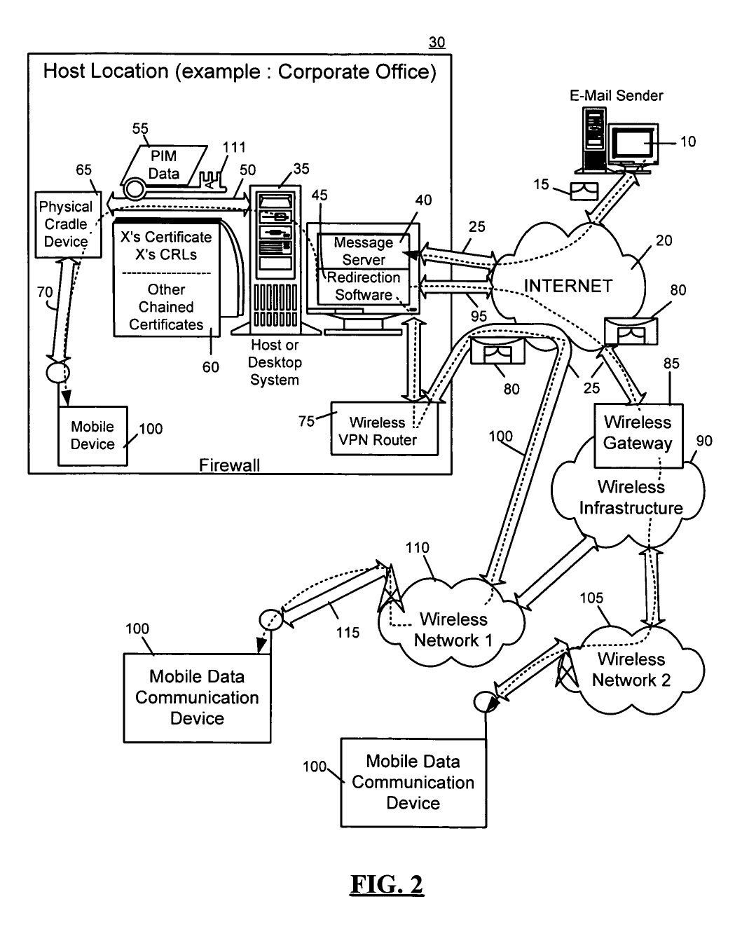

FIG. 2 is a block diagram of a further example communication system including multiple networks and multiple mobile communication devices. The system of FIG. 2 is substantially similar to the FIG. 1 system, but includes a host system 30, a redirection program 45, a mobile device cradle 65, a wireless virtual private network (VPN) router 75, an additional wireless network 110 and multiple mobile communication devices 100. As described above in conjunction with FIG. 1, FIG. 2 represents an overview of a sample network topology. Although the encoded message processing systems and methods described herein may be applied to networks having many different topologies, the network of FIG. 2 is useful in understanding an automatic e-mail redirection system mentioned briefly above.

The central host system 30 will typically be a corporate office or other LAN, but may instead be a home office computer or some other private system where mail messages are being exchanged. Within the host system 30 is the message server 40, running on some computer within the firewall of the host system, that acts as the main interface for the host system to exchange e-mail with the Internet 20. In the system of FIG. 2, the redirection program 45 enables redirection of data items from the server 40 to a mobile communication device 100. Although the redirection program 45 is shown to reside on the same machine as the message server 40 for ease of presentation, there is no requirement that it must reside on the message server. The redirection program 45 and the message server 40 are designed to co-operate and interact to allow the pushing of information to mobile devices 100. In this installation, the redirection program 45 takes confidential and non-confidential corporate information for a specific user and redirects it out through the corporate firewall to mobile devices 100. A more detailed description of the redirection software 45 may be found in the commonly assigned U.S. Pat. No. 6,219,694 (“the '694 Patent”), entitled “System and Method for Pushing Information From A Host System To A Mobile Data Communication Device Having A Shared Electronic Address”, and issued to the assignee of the instant application on Apr. 17, 2001, which is hereby incorporated into the present application by reference. This push technique may use a wireless friendly encoding, compression and encryption technique to deliver all information to a mobile device, thus effectively extending the security firewall to include each mobile device 100 associated with the host system 30.

As shown in FIG. 2, there may be many alternative paths for getting information to the mobile device 100. One method for loading information onto the mobile device 100 is through a port designated 50, using a device cradle 65. This method tends to be useful for bulk information updates often performed at initialization of a mobile device 100 with the host system 30 or a computer 35 within the system 30. The other main method for data exchange is over-the-air using wireless networks to deliver the information. As shown in FIG. 2, this may be accomplished through a wireless VPN router 75 or through a traditional Internet connection 95 to a wireless gateway 85 and a wireless infrastructure 90, as described above. The concept of a wireless VPN router 75 is new in the wireless industry and implies that a VPN connection could be established directly through a specific wireless network 110 to a mobile device 100. The possibility of using a wireless VPN router 75 has only recently been available. It is expected to be used when the new Internet Protocol (IP) Version 6 (IPV6) is deployed into IP-based wireless networks. This new protocol will provide enough IP addresses to dedicate an EP address to every mobile device 100 and thus make it possible to push information to a mobile device 100 at any time. A principal advantage of using this wireless VPN router 75 is that it could be an off-the-shelf VPN component, thus it would not require a separate wireless gateway 85 and wireless infrastructure 90 to be used. A VPN connection would preferably be a Transmission Control Protocol (TCP)/IP or User Datagram Protocol (UDP)/IP connection to deliver the messages directly to the mobile device 100. If a wireless VPN 75 is not available then a link 95 to the Internet 20 is the most common connection mechanism available and has been described above.

In the automatic redirection system of FIG. 2, a composed e-mail message 15 leaving the e-mail sender 10 arrives at the message server 40 and is redirected by the redirection program 45 to the mobile device 100. As this redirection takes place the message 15 is re-enveloped, as indicated at 80, and a possibly proprietary compression and encryption algorithm can then be applied to the original message 15. In this way, messages being read on the mobile device 100 are no less secure than if they were read on a desktop workstation such as 35 within the firewall. All messages exchanged between the redirection program 45 and the mobile device 100 preferably use this message repackaging technique. Another goal of this outer envelope is to maintain the addressing information of the original message except the sender's and the receiver's address. This allows reply messages to reach the appropriate destination, and also allows the “from” field to reflect the mobile user's desktop address. Using the user's e-mail address from the mobile device 100 allows the received message to appear as though the message originated from the user's desktop system 35 rather than the mobile device 100.

With reference back to the port 50 and cradle 65 connectivity to the mobile device 100, this connection path offers many advantages for enabling one-time data exchange of large items. For those skilled in the art of personal digital assistants (PDAs) and synchronization, the most common data exchanged over this link is Personal Information Management (PIM) data 55. When exchanged for the first time this data tends to be large in quantity, bulky in nature and requires a large bandwidth to get loaded onto the mobile device 100 where it can be used on the road. This serial link may also be used for other purposes, including setting up a private security key 111 such as an S/MIME or PGP specific private key, the Certificate (Cert) of the user and their Certificate Revocation Lists (CRLs) 60. The private key is preferably exchanged so that the desktop 35 and mobile device 100 share one personality and one method for accessing all mail. The Cert and CRLs are normally exchanged over such a link because they represent a large amount of the data that is required by the device for S/MIME, PGP and other public key security methods.

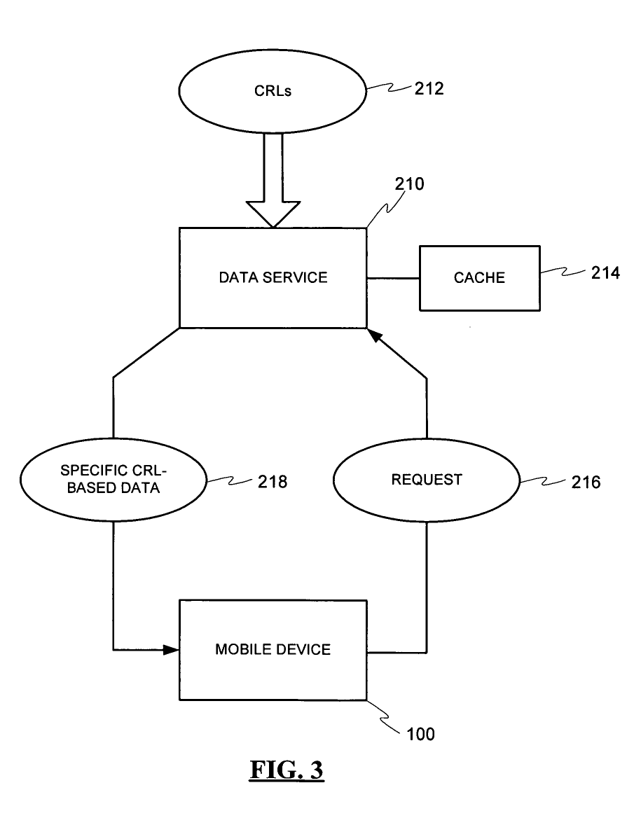

As shown in FIG. 3, a system is provided which utilizes a data service 210 to download the CRLs 212 for providing a status of a certificate to a mobile device upon request. The data service 210 can provide a secure gateway between a wireless network and corporate intranets and the Internet as well as facilitate wireless data transfers between the handheld mobile device 100 and remote servers (e.g., LDAP and PKI servers). The data service 210 can perform status searches of the digital certificates received by the mobile wireless device 100, and the data service 210 can be located on a server that handles delivery of messages to and receives messages from the mobile wireless device (such as message server system 40 on FIG. 1). An example of a data service is the Mobile Data Service (MDS) developed by the assignee of this application.

A CRL is downloaded and could be cached by the data service 210 in a cache 214. Other information, such as the public key of the certificate of a CA, can also be cached in the cache 214 for the faster performance of verification operations. When the mobile device 100 needs to verify the status of a digital certificate, it can send a request 216 to the data service 210. The request for status of the digital certificate can include a certificate identifier. The status of the requested certificate is checked against the CRL, which may be stored in cache 214. The information pertaining to the requested certificate 218 is then sent back to the mobile device 100.

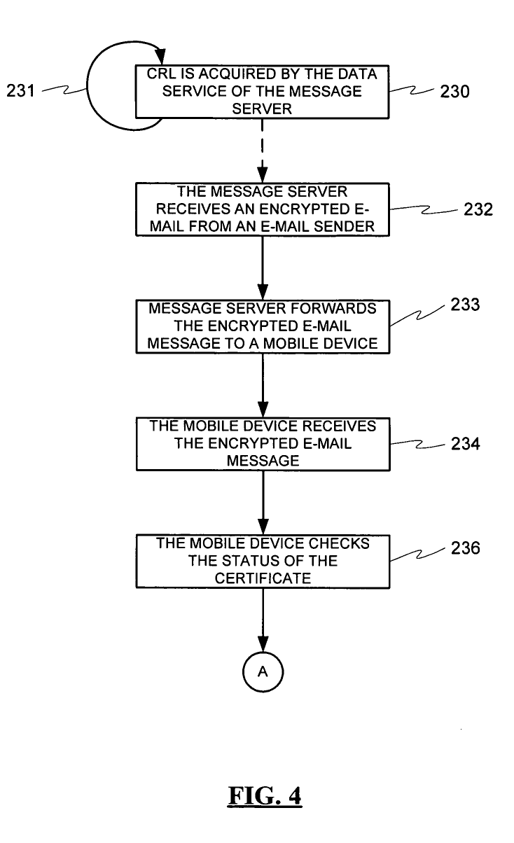

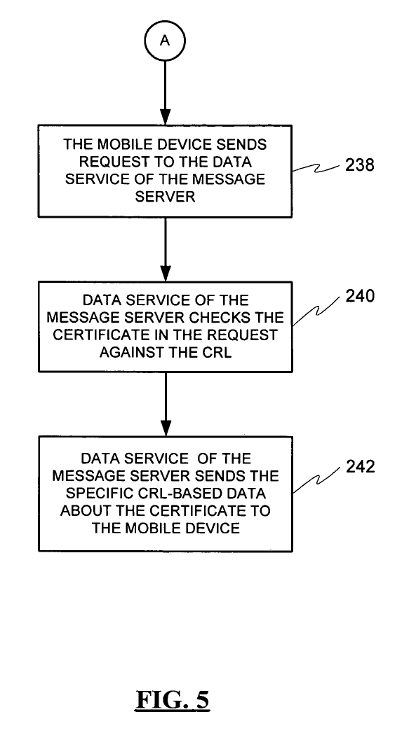

FIGS. 4 and 5 provide an example operational scenario wherein a certificate verification process is performed. With reference to FIG. 4, a data service acquires a CRL in step 230. This step may occur asynchronously with other steps, which is shown by the looping arrow 231. In step 232, the message server receives a secure message (e.g., a message which is encrypted with a digital certificate and/or digitally signed). The message may be an e-mail message or a different type of message. In step 233, the message server forwards the message to a mobile device which is identified as a destination for the message. In step 234, the mobile device receives the secure e-mail message. In step 236, the mobile device decides to check the status of the certificate which was used to sign the message.

In step 238 depicted on FIG. 5, the mobile device forms a request, which includes the certificate's identification and sends it to the data service. In step 240, the data service receives the request and checks the certificate's identification against the most recently acquired CRL. In step 242, the data service sends the specific CRL-based data to the mobile device. The data may include the indication of whether the certificate has been revoked and possibly other information. All of the communication between the message server 40 and the mobile device 100 may be further encrypted for additional security as mentioned above.

This operational scenario illustrates that a system can be configured to enable verifying the status of a given certificate without having to download a CRL to the mobile device. The system can be configured such that a mobile device never has the CRL downloaded, and the message server always keeps the CRL accessible to the mobile device. The operational scenario is distinguished from OCSP in many ways, such as, but not limited to, that the method does not require a separate “responder” server and the message server 40 which forwards the message to the mobile device 100 is used to verify the status of the digital certificate.

The system in the operational scenario may be configured to also provide a generic framework for use with all types of PKI systems if they store their CRLs in a system (e.g., an LDAP system) that can be fetched by the mobile device. The system can be extended so that any useful information from the mobile device (such as the CRL distribution point) is sent down to the mobile device for use by the data service in retrieving the status of the certificate.

A data service with the systems and methods disclosed herein can provide other benefits over an OCSP server, such as the data service being securely located behind a corporate firewall. In addition, more information can be sent down regarding the certificate and its possible CRL location that might not possibly be sent down to an OCSP server. Such information can include the issuer's public key. Furthermore, the OCSP protocol can be fixed whereas the system is extensible. For example, the data service could store CRLs from multiple sources, such as a CRL from a Department of Defense server and a CRL from a corporate server. As another example, a system can be configured to support checking the status of PGP certificates. PGP certificate status checking approaches do not implement a centralized authority (which keeps the most up to date status of all keys on that system and distributes certificate revocation lists, indicating which certificates have been revoked). Instead, PGP implements “a web of trust,” a method where other entities, other than a centralized authority, authenticate the keys by “signing” them. Other users may or may not consider a key authentic depending on the combination of entities which signed a given key. PGP allows keys to be stored on key servers. The owner of a key may change the status of his key on a server, for example the owner may revoke the key. Also other users may change the status of the key by signing it or removing their signature. Accordingly within a PGP computer environment, a system can be configured to obtain a key of another user from a key server for the purposes of encryption and authentication, and to verify the key to determine that it has not been revoked by the owner and that it can still be trusted based on combination of signatures associated with it.

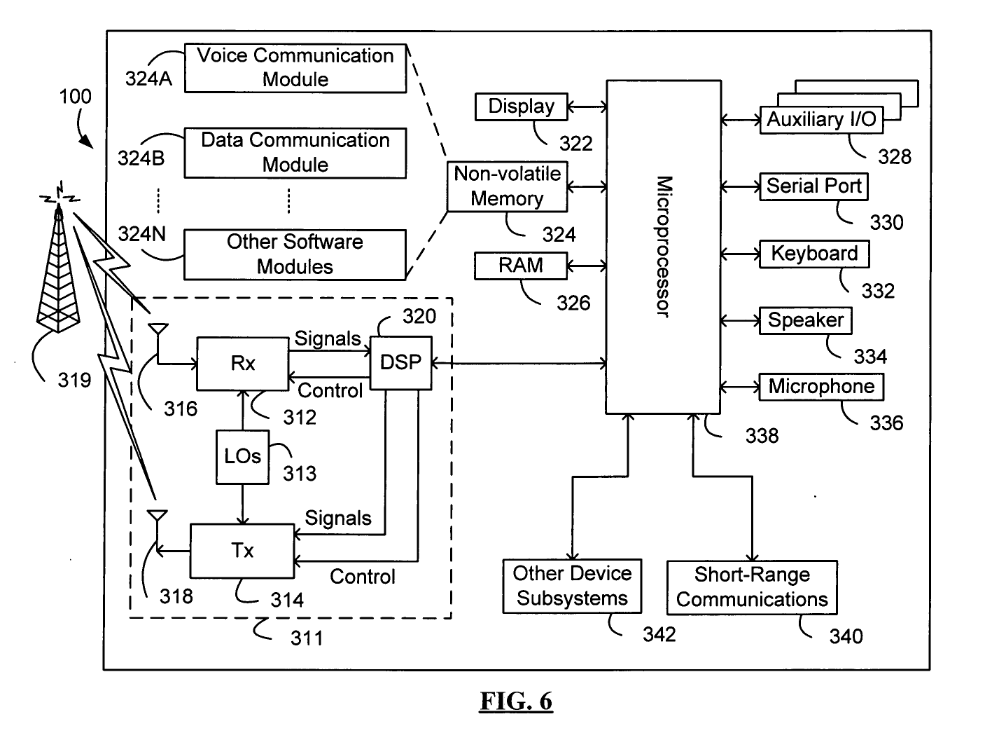

The systems and methods disclosed herein are presented only by way of example and are not meant to limit the scope of the invention. Other variations of the systems and methods described above will be apparent to those skilled in the art and as such are considered to be within the scope of the invention. For example, the systems and methods disclosed herein may be used with many different computers and devices, such as a wireless mobile communications device shown in FIG. 6. With reference to FIG. 6, the mobile device 100 is a dual-mode mobile device and includes a transceiver 311, a microprocessor 338, a display 322, non-volatile memory 324, random access memory (RAM) 326, one or more auxiliary input/output (I/O) devices 328, a serial port 330, a keyboard 332, a speaker 334, a microphone 336, a short-range wireless communications sub-system 340, and other device sub-systems 342.

The transceiver 311 includes a receiver 312, a transmitter 314, antennas 316 and 318, one or more local oscillators 313, and a digital signal processor (DSP) 320. The antennas 316 and 318 may be antenna elements of a multiple-element antenna, and are preferably embedded antennas. However, the systems and methods described herein are in no way restricted to a particular type of antenna, or even to wireless communication devices.

The mobile device 100 is preferably a two-way communication device having voice and data communication capabilities. Thus, for example, the mobile device 100 may communicate over a voice network, such as any of the analog or digital cellular networks, and may also communicate over a data network. The voice and data networks are depicted in FIG. 6 by the communication tower 319. These voice and data networks may be separate communication networks using separate infrastructure, such as base stations, network controllers, etc., or they may be integrated into a single wireless network.

The transceiver 311 is used to communicate with the network 319, and includes the receiver 312, the transmitter 314, the one or more local oscillators 313 and the DSP 320. The DSP 320 is used to send and receive signals to and from the transceivers 316 and 318, and also provides control information to the receiver 312 and the transmitter 314. If the voice and data communications occur at a single frequency, or closely-spaced sets of frequencies, then a single local oscillator 313 may be used in conjunction with the receiver 312 and the transmitter 314. Alternatively, if different frequencies are utilized for voice communications versus data communications for example, then a plurality of local oscillators 313 can be used to generate a plurality of frequencies corresponding to the voice and data networks 319. Information, which includes both voice and data information, is communicated to and from the transceiver 311 via a link between the DSP 320 and the microprocessor 338.

The detailed design of the transceiver 311, such as frequency band, component selection, power level, etc., will be dependent upon the communication network 319 in which the mobile device 100 is intended to operate. For example, a mobile device 100 intended to operate in a North American market may include a transceiver 311 designed to operate with any of a variety of voice communication networks, such as the Mobitex or DataTAC mobile data communication networks, AMPS, TDMA, CDMA, PCS, etc., whereas a mobile device 100 intended for use in Europe may be configured to operate with the GPRS data communication network and the GSM voice communication network. Other types of data and voice networks, both separate and integrated, may also be utilized with a mobile device 100.

Depending upon the type of network or networks 319, the access requirements for the mobile device 100 may also vary. For example, in the Mobitex and DataTAC data networks, mobile devices are registered on the network using a unique identification number associated with each mobile device. In GPRS data networks, however, network access is associated with a subscriber or user of a mobile device. A GPRS device typically requires a subscriber identity module (“SIM”), which is required in order to operate a mobile device on a GPRS network. Local or non-network communication functions (if any) may be operable, without the SIM device, but a mobile device will be unable to carry out any functions involving communications over the data network 319, other than any legally required operations, such as ‘911’ emergency calling.

After any required network registration or activation procedures have been completed, the mobile device 100 may the send and receive communication signals, including both voice and data signals, over the networks 319. Signals received by the antenna 316 from the communication network 319 are routed to the receiver 312, which provides for signal amplification, frequency down conversion, filtering, channel selection, etc., and may also provide analog to digital conversion. Analog to digital conversion of the received signal allows more complex communication functions, such as digital demodulation and decoding to be performed using the DSP 320. In a similar manner, signals to be transmitted to the network 319 are processed, including modulation and encoding, for example, by the DSP 320 and are then provided to the transmitter 314 for digital to analog conversion, frequency up conversion, filtering, amplification and transmission to the communication network 319 via the antenna 318.

In addition to processing the communication signals, the DSP 320 also provides for transceiver control. For example, the gain levels applied to communication signals in the receiver 312 and the transmitter 314 may be adaptively controlled through automatic gain control algorithms implemented in the DSP 320. Other transceiver control algorithms could also be implemented in the DSP 320 in order to provide more sophisticated control of the transceiver 311.

The microprocessor 338 preferably manages and controls the overall operation of the mobile device 100. Many types of microprocessors or microcontrollers could be used here, or, alternatively, a single DSP 320 could be used to carry out the functions of the microprocessor 338. Low-level communication functions, including at least data and voice communications, are performed through the DSP 320 in the transceiver 311. Other, high-level communication applications, such as a voice communication application 324A, and a data communication application 324B may be stored in the non-volatile memory 324 for execution by the microprocessor 338. For example, the voice communication module 324A may provide a high-level user interface operable to transmit and receive voice calls between the mobile device 100 and a plurality of other voice or dual-mode devices via the network 319. Similarly, the data communication module 324B may provide a high-level user interface operable for sending and receiving data, such as e-mail messages, files, organizer information, short text messages, etc., between the mobile device 100 and a plurality of other data devices via the networks 319.

The microprocessor 338 also interacts with other device subsystems, such as the display 322, the RAM 326, the auxiliary input/output (I/O) subsystems 328, the serial port 330, the keyboard 332, the speaker 334, the microphone 336, the short-range communications subsystem 340 and any other device subsystems generally designated as 342.

Some of the subsystems shown in FIG. 6 perform communication-related functions, whereas other subsystems may provide “resident” or on-device functions. Notably, some subsystems, such as the keyboard 332 and the display 322 may be used for both communication-related functions, such as entering a text message for transmission over a data communication network, and device-resident functions such as a calculator or task list or other PDA type functions.

Operating system software used by the microprocessor 338 is preferably stored in a persistent store such as non-volatile memory 324. The non-volatile memory 324 may be implemented, for example, as a Flash memory component, or as battery backed-up RAM. In addition to the operating system, which controls low-level functions of the mobile device 310, the non-volatile memory 324 includes a plurality of software modules 324A-324N that can be executed by the microprocessor 338 (and/or the DSP 320), including a voice communication module 324A, a data communication module 324B, and a plurality of other operational modules 324N for carrying out a plurality of other functions. These modules are executed by the microprocessor 338 and provide a high-level interface between a user and the mobile device 100. This interface typically includes a graphical component provided through the display 322, and an input/output component provided through the auxiliary I/O 328, keyboard 332, speaker 334, and microphone 336. The operating system, specific device applications or modules, or parts thereof, may be temporarily loaded into a volatile store, such as RAM 326 for faster operation. Moreover, received communication signals may also be temporarily stored to RAM 326, before permanently writing them to a file system located in a persistent store such as the Flash memory 324.

An exemplary application module 324N that may be loaded onto the mobile device 100 is a personal information manager (PIM) application providing PDA functionality, such as calendar events, appointments, and task items. This module 324N may also interact with the voice communication module 324A for managing phone calls, voice mails, etc., and may also interact with the data communication module for managing e-mail communications and other data transmissions. Alternatively, all of the functionality of the voice communication module 324A and the data communication module 324B may be integrated into the PIM module.

The non-volatile memory 324 preferably also provides a file system to facilitate storage of PIM data items on the device. The PIM application preferably includes the ability to send and receive data items, either by itself, or in conjunction with the voice and data communication modules 324A, 324B, via the wireless networks 319. The PIM data items are preferably seamlessly integrated, synchronized and updated, via the wireless networks 319, with a corresponding set of data items stored or associated with a host computer system, thereby creating a mirrored system for data items associated with a particular user.

Context objects representing at least partially decoded data items, as well as fully decoded data items, are preferably stored on the mobile device 100 in a volatile and non-persistent store such as the RAM 326. Such information may instead be stored in the non-volatile memory 324, for example, when storage intervals are relatively short, such that the information is removed from memory soon after it is stored. However, storage of this information in the RAM 326 or another volatile and non-persistent store is preferred, in order to ensure that the information is erased from memory when the mobile device 100 loses power. This prevents an unauthorized party from obtaining any stored decoded or partially decoded information by removing a memory chip from the mobile device 100, for example.

The mobile device 100 may be manually synchronized with a host system by placing the device 100 in an interface cradle, which couples the serial port 330 of the mobile device 100 to the serial port of a computer system or device. The serial port 330 may also be used to enable a user to set preferences through an external device or software application, or to download other application modules 324N for installation. This wired download path may be used to load an encryption key onto the device, which is a more secure method than exchanging encryption information via the wireless network 319. Interfaces for other wired download paths may be provided in the mobile device 100, in addition to or instead of the serial port 330. For example, a USB port would provide an interface to a similarly equipped personal computer.

Additional application modules 324N may be loaded onto the mobile device 100 through the networks 319, through an auxiliary I/O subsystem 328, through the serial port 330, through the short-range communications subsystem 340, or through any other suitable subsystem 342, and installed by a user in the non-volatile memory 324 or RAM 326. Such flexibility in application installation increases the functionality of the mobile device 100 and may provide enhanced on-device functions, communication-related functions, or both. For example, secure communication applications may enable electronic commerce functions and other such financial transactions to be performed using the mobile device 100.

When the mobile device 100 is operating in a data communication mode, a received signal, such as a text message or a web page download, is processed by the transceiver module 311 and provided to the microprocessor 338, which preferably further processes the received signal in multiple stages as described above, for eventual output to the display 322, or, alternatively, to an auxiliary I/O device 328. A user of mobile device 100 may also compose data items, such as e-mail messages, using the keyboard 332, which is preferably a complete alphanumeric keyboard laid out in the QWERTY style, although other styles of complete alphanumeric keyboards such as the known DVORAK style may also be used. User input to the mobile device 100 is further enhanced with a plurality of auxiliary I/O devices 328, which may include a thumbwheel input device, a touchpad, a variety of switches, a rocker input switch, etc. The composed data items input by the user may then be transmitted over the communication networks 319 via the transceiver module 311.

When the mobile device 100 is operating in a voice communication mode, the overall operation of the mobile device is substantially similar to the data mode, except that received signals are preferably be output to the speaker 334 and voice signals for transmission are generated by a microphone 336. Alternative voice or audio I/O subsystems, such as a voice message recording subsystem, may also be implemented on the mobile device 100. Although voice or audio signal output is preferably accomplished primarily through the speaker 334, the display 322 may also be used to provide an indication of the identity of a calling party, the duration of a voice call, or other voice call related information. For example, the microprocessor 338, in conjunction with the voice communication module and the operating system software, may detect the caller identification information of an incoming voice call and display it on the display 322.

A short-range communications subsystem 340 is also included in the mobile device 100. The subsystem 340 may include an infrared device and associated circuits and components, or a short-range RF communication module such as a Bluetooth™ module or an 802.11 module, for example, to provide for communication with similarly-enabled systems and devices. Those skilled in the art will appreciate that “Bluetooth” and “802.11” refer to sets of specifications, available from the Institute of Electrical and Electronics Engineers, relating to wireless personal area networks and wireless local area networks, respectively.

The systems' and methods' data may be stored in one or more data stores. The data stores can be of many different types of storage devices and programming constructs, such as RAM, ROM, Flash memory, programming data structures, programming variables, etc. It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

1. A method for use upon a computer-based message server to verify a status of a digital certificate, comprising:
acquiring a certificate revocation list (CRL);
receiving a message secured with the digital certificate;
sending the secured message with the digital certificate to a remote system;
receiving a request for the status of the digital certificate from the remote system;
determining the status of the digital certificate by examining the CRL;
sending a response with the status of the digital certificate to the remote system.

2. The method of claim 1, wherein the remote system is a wireless mobile communication device.

3. The method of claim 2, wherein the secured message is an encrypted e-mail message.

4. The method of claim 3, wherein the request for status of the digital certificate comprises a certificate identifier.

5. The method of claim 4, wherein the response with the status of the digital certificate comprises an indicia of whether the digital certificate is revoked.

6. The method of claim 5, wherein communications with the remote system are encrypted.

7. The method of claim 1, wherein the remote system is a user within a Public Key Infrastructure (PKI) system, wherein the PKI system does not include an Online Certificate Status Protocol (OCSP) provider.

8. The method of claim 7, wherein the remote system receives the status of the digital certificate although the PKI system does not include an OCSP provider.

9. The method of claim 1, wherein the certificate revocation list is acquired by pulling the certificate revocation list from a certificate authority.

10. The method of claim 1, wherein the certificate revocation list is acquired by pushing the certificate revocation list from a certificate authority.

11. A data signal that is transmitted by the method of claim 1 using a computer network, wherein the data signal includes the status of the digital certificate that was generated in response to the request for the status of the digital certificate from a remote system, wherein the data signal is packetized data that is transmitted through a carrier wave across the network.

12. The data signal of claim 11, wherein the destination of the data signal is a mobile data communication device.

13. The data signal of claim 11, wherein the data signal traverses both wire line and wireless media.

14. Computer-readable medium capable of causing a messaging server to perform the method of claim 1.

15. The method of claim 1, wherein the acquired CRL is downloaded and stored in cache.

16. The method of claim 15, wherein public key of the certificate of a certificate authority is stored in the cache in order to increase performance associated with digital certificate verification operations.

17. The method of claim 1, wherein a wireless mobile communications device sends a request to a data service operating on a server which performs the steps of claim 1, wherein status of a certificate which is an object of the mobile device's request is checked by the data service with respect to the acquired CRL; wherein verification information pertaining to the requested certificate is sent back to the requesting mobile device.

18. The method of claim 17, wherein because the server provides the verification response to the mobile device removes the need for the mobile device to download the CRL.

19. The method of claim 18, wherein the data service is securely located behind a corporate firewall; wherein information is sent to the requesting mobile device regarding the issuer's public key.

20. A message server for verifying a status of a digital certificate, comprising:
a connection to a computer network for communicating with a certificate authority (CA);
wherein a certificate revocation list (CRL) is acquired from the certificate authority;
a connection to a remote wireless communication device;
computer instructions configured to receive a message secured with the digital certificate;
computer instructions configured to send the secured message with the digital certificate to a remote system;
computer instructions configured to receive a request for the status of the digital certificate from the remote system;
computer instructions configured to determine the status of the digital certificate by examining the CRL;
computer instructions configured to send a response with the status of the digital certificate to the remote system.

21. The system of claim 20, wherein the message server is a server system comprising multiple computer servers.
